(19) United States
(12) Patent Application Publication
(10) Pub. No.: US 2023/0303058 A1
(43) Pub. Date: Sep. 28, 2023

(54) DIAGNOSING APPARATUS AND DIAGNOSING METHOD FOR HYBRID ELECTRIC VEHICLE

(71) Applicant: TOYOTA JIDOSHA KABUSHIKI KAISHA, Toyota-shi (JP)

(72) Inventor: Takumi ANZAWA, Okazaki-shi (JP)

(73) Assignee: TOYOTA JIDOSHA KABUSHIKI KAISHA, Toyota-shi (JP)

(21) Appl. No.: 18/169,949

(22) Filed: Feb. 16, 2023

(30) Foreign Application Priority Data
Mar. 22, 2022 (JP) 2022-045475

(51) Int. Cl. B60W 20/10; B60W 50/02; B60W 10/06; B60W 10/08; B60W 10/02

(52) U.S. Cl. CPC B60W 20/10; B60W 50/0205; B60W 10/06; B60W 10/08; B60W 10/02; B60W 2510/244; B60W 2510/0208

(57) ABSTRACT

A diagnosing apparatus is configured to diagnose a hybrid electric vehicle. The diagnosing apparatus is configured to execute a load operation diagnosis process of diagnosing the engine when a specific execution condition is satisfied during a load operation of the engine. The diagnosing apparatus is further configured to execute an early execution process of a load operation diagnosis. The early execution process performs the load operation of the engine to satisfy an execution condition of the load operation diagnosis process in a state in which load is applied to the engine by the first motor while the first clutch is engaged and the second clutch is disengaged so that the vehicle travels with the driving force generated by the second motor.

### BACKGROUND

### 1. Field

The present disclosure relates to a diagnosing apparatus and a diagnosing method for a hybrid electric vehicle.

### 2. Description of Related Art

As a diagnosing apparatus for a vehicle, there is an apparatus for diagnosing an engine. Diagnosis items of the engine include an item that is desirably executed in a stable operating state during idling operation. On the other hand, for the purpose of improving emission and reducing fuel consumption, some vehicles automatically stop the engine in a situation in which the engine is in an idling operation such as when the vehicle is stopped. In such a vehicle in which the engine is automatically stopped, since the frequency of performing the idling operation is low, the opportunity to perform diagnosis during the idling operation is limited.

A diagnosing apparatus for a vehicle described in Japanese Laid-Open Patent Publication No. 2008-151041 prohibits automatic stop of the engine when there is an incomplete diagnosis at the time when an automatic stop condition is satisfied. The diagnosing apparatus ensures an opportunity to perform diagnosis during an idling operation by performing an idling operation instead of automatic stop.

The diagnosis items of an engine include an item that is desired to be executed under a specific operating condition during load operation. However, since the operating state of the engine constantly changes in accordance with the traveling state of the vehicle, the opportunity to obtain an operating state desirable for diagnosis is limited. In particular, in a hybrid electric vehicle capable of electric traveling by a motor, since the engine may be stopped even during traveling of the vehicle, opportunities to perform engine diagnosis during the load operation are further limited.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a diagnosing apparatus for a hybrid electric vehicle is provided. The hybrid electric vehicle includes an engine that generates driving force by combustion of fuel, a first motor that generates electric power by receiving external force, a second motor that generates force in response to power supply, a battery that is charged and discharged, and a first clutch and a second clutch that selectively allow for and interrupt force transmission. The first clutch, the first motor, and the second clutch are arranged in that order from the engine toward wheels in a transmission path of the driving force. The diagnosing apparatus is configured to execute a load operation diagnosis process of diagnosing the engine when a specified execution condition is satisfied during a load operation of the engine, and an early execution process of a load operation diagnosis. The early execution process performs the load operation of the engine to satisfy an execution condition of the load operation diagnosis process in a state in which load is applied to the engine by the first motor while the first clutch is engaged and the second clutch is disengaged so that the vehicle travels with the driving force generated by the second motor.

When the diagnosing apparatus executes the early execution process of the load operation diagnosis, the engine and the first motor are connected to each other and disconnected from the wheels. The hybrid electric vehicle travels by the driving force generated by the second motor. In this state, the load applied to the engine can be adjusted by changing the regenerative torque of the first motor. At this time, the engine and the first motor are disconnected from the wheels. Therefore, at this time, the engine can be brought into a desired operating state regardless of the traveling state of the hybrid electric vehicle. In the diagnosing apparatus, the load operation of the engine is performed to satisfy the execution condition of the load operation diagnosis process by the early execution process of the load operation diagnosis process. Therefore, when the early execution process of the load operation diagnosis process is executed, the load operation diagnosis process can be executed regardless of the traveling state of the hybrid electric vehicle. Therefore, the diagnosing apparatus for the hybrid electric vehicle enables early execution of the engine diagnosis during the load operation.

In the early execution process during the load operation, a load is applied to the engine by the regenerative operation of the first motor. At this time, if the battery is fully charged or in a state close thereto, the electric power generated by the first motor through the regenerative operation cannot be recovered to the battery. Therefore, it is desirable that the early execution process of the load operation diagnosis in the diagnosing apparatus be executed on condition that the battery has a remaining chargeable capacity that is equal to or greater than a certain level.

In some cases, such as when the charge amount of the battery is relatively low, the engine may be required to perform regenerative operation of the first motor to charge the battery. On the other hand, in the early execution process of the load operation diagnosis, the first motor generates electric power while the second motor consumes electric power. Thus, the charge amount of the battery may be reduced. Therefore, it is desirable that the early execution process during a load operation in the diagnosing apparatus be executed on condition that the driving of the engine for charging the battery is not requested.

There is a limit to the driving force that can be generated by the second motor. Thus, the driving force requested by the driver may not be satisfied by the driving force generated by the second motor alone. Therefore, it is desirable that the early execution process during a load operation in the diagnosing apparatus be executed on condition that the maximum value of the driving force that can be generated by the second motor is greater than the driving force requested by the driver.

The hybrid electric vehicle for the hybrid electric vehicle may be configured to further execute an idling operation diagnosis process of diagnosing the engine on condition that the engine is in an idling operation, and an early execution process of the idling operation diagnosis process. The early execution process performs the idling operation of the engine while the first clutch is disengaged and the second clutch is engaged so that the vehicle travels with the driving force generated by one or both of the first motor and the second motor. When the early execution process of the idling operation diagnosis is executed, the first motor is connected to the wheels, but the engine is disconnected from the wheels. At this time, the hybrid electric vehicle can travel by the driving force generated by one or both of the first motor and the second motor. On the other hand, since the engine at this time is disconnected from the wheels, the idling operation can be performed regardless of the traveling state. Therefore, by executing the early execution process of the idling operation diagnosis, the idling operation diagnosis process can be executed regardless of the traveling state of the hybrid electric vehicle. It is desirable that the early execution process of the idling operation diagnosis be executed on condition that the driving of the engine for charging the battery is not requested. In addition, it is desirable that the early execution process of the idling operation diagnosis be executed on condition that the maximum value of the driving force that can be generated by the first motor and the second motor is greater than the driving force requested by the driver.

Other features and aspects will be apparent from the following detailed description, the drawings, and the claims.

### BRIEF DESCRIPTION OF THE DRAWINGS

FIG. 1 is a diagram schematically showing a configuration of a drive system of a hybrid electric vehicle in which a diagnosing apparatus according to an embodiment is used.

FIG. 2 is a diagram schematically showing a configuration of the diagnosing apparatus according to the embodiment.

FIG. 3 is a diagram showing a state of the drive system of the hybrid electric vehicle shown in FIG. 1 in a hybrid traveling mode.

FIG. 4 is a diagram showing a state of the drive system of the hybrid electric vehicle shown in FIG. 1 in an electric traveling mode.

FIG. 5 is a flowchart of a forced execution routine of a load operation diagnosis performed by the diagnosing apparatus shown in FIG. 2.

FIG. 6 is a flowchart of a forced execution routine of an idling operation diagnosis performed by the diagnosing apparatus shown in FIG. 2.

FIG. 7 is a diagram showing a state during forced execution of the load operation diagnosis in the drive system of the hybrid electric vehicle shown in FIG. 1.

FIG. 8 is a diagram showing a state during forced execution of the idling operation diagnosis in the drive system of the hybrid electric vehicle shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

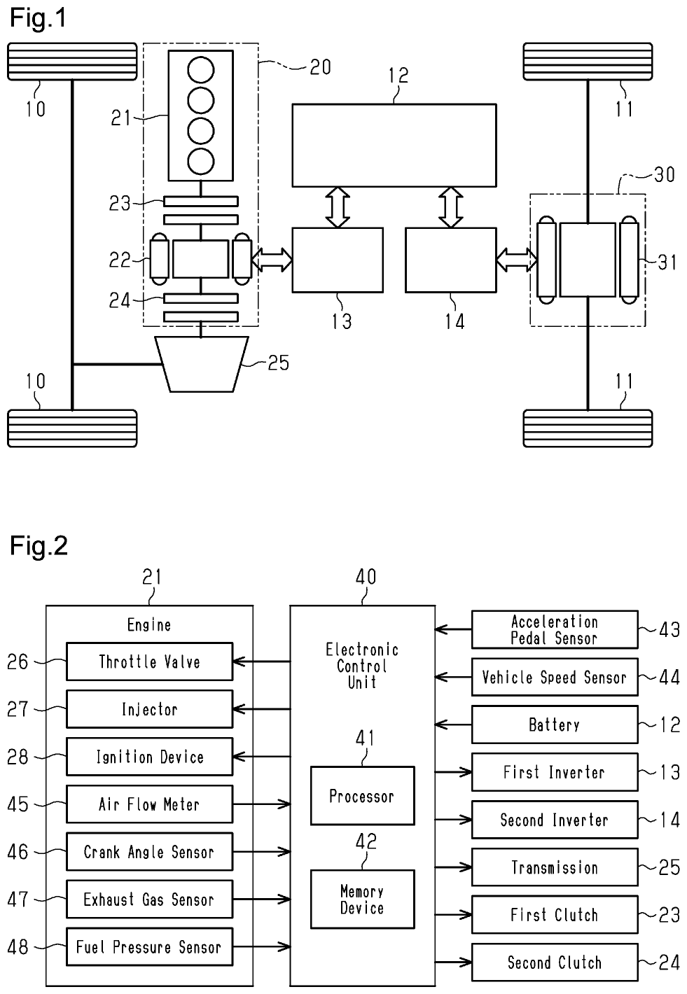

Hereinafter, a diagnosing apparatus for a hybrid electric vehicle according to one embodiment will be described in detail with reference to FIGS. 1 to 8.

<Configuration of Drive System of Hybrid Electric Vehicle>

First, with reference to FIG. 1, a configuration of a drive system of a hybrid electric vehicle in which the diagnosing apparatus of the present embodiment is used will be described. The hybrid electric vehicle has four wheels: left and right front wheels 10 and left and right rear wheels 11. The hybrid electric vehicle includes two power units, i.e., a first power unit 20 for driving the left and right front wheels 10 and a second power unit 30 for driving the left and right rear wheels 11. A chargeable and dischargeable battery 12 is mounted on the hybrid electric vehicle.

The first power unit 20 is coupled to the left and right front wheels 10 via a transmission 25. The first power unit 20 includes two drive sources, i.e., an engine 21 that generates a driving force by combustion of fuel and a first motor 22 that generates a driving force in response to power supplied from the battery 12 and receives power from the outside to generate electric power. The first motor 22 is electrically connected to the battery 12 via a first inverter 13. The first power unit 20 is provided with two clutches that selectively allow for and interrupt force transmission, that is, a first clutch 23 and a second clutch 24. The engine 21 is coupled to the first motor 22 via the first clutch 23. The first motor 22 is connected to a transmission 25 via the second clutch 24. That is, the first clutch 23, the first motor 22, and the second clutch 24 are arranged in that order from the side closer to the engine 21 in the transmission path of the driving force from the engine 21 to the front wheels 10.

The second power unit 30 includes, as a drive source, a second motor 31 that generates a driving force in response to power supplied from the battery 12 and receives power from the outside to generate electric power. The second motor 31 is directly coupled to the left and right rear wheels 11. The second motor 31 is electrically connected to the battery 12 via the second inverter 14.

<Configuration of Diagnosing Apparatus>

Next, referring to FIG. 2, a configuration of a diagnosing apparatus for a hybrid electric vehicle will be described.

The hybrid electric vehicle is equipped with an electronic control unit (ECU) 40 for vehicle control. The electronic control unit 40 includes a processor 41 and a memory device 42. The memory device 42 stores programs and data for vehicle control. The processor 41 reads programs from the memory device 42 and executes the programs, whereby the electronic control unit 40 performs vehicle control. The electronic control unit 40 diagnoses the hybrid electric vehicle as part of the vehicle control. In the present embodiment, the electronic control unit 40 constitutes a diagnosing apparatus for a hybrid electric vehicle.

Detection signals of various sensors are input to the electronic control unit 40. Such sensors include an accelerator pedal sensor 43, a vehicle speed sensor 44, an air flow meter 45, a crank angle sensor 46, an exhaust gas sensor 47, and a fuel pressure sensor 48. The accelerator pedal sensor 43 is a sensor that detects an operation amount of an accelerator pedal by the driver. The vehicle speed sensor 44 is a sensor that detects a vehicle speed that is a traveling speed of the hybrid electric vehicle. The air flow meter 45 is a sensor that detects an intake air amount of the engine 21. The crank angle sensor 46 is a sensor that detects a rotational phase of a crankshaft, which is an output shaft of the engine 21. The exhaust gas sensor 47 is a sensor, such as an air-fuel ratio sensor, an oxygen sensor, or a NOx sensor, that detects an exhaust gas property of the engine 21. The fuel pressure sensor 48 is a sensor that detects a fuel supply pressure of the engine 21. A signal indicating a charge amount of the battery 12 is input to the electronic control unit 40.

The electronic control unit 40 controls the hybrid electric vehicle by controlling the engine 21, the first motor 22, the second motor 31, the transmission 25, the first clutch 23, and the second clutch 24 based on the detection results of the sensors. The engine 21 is provided with a throttle valve 26 for adjusting an intake air amount, an injector 27 for injecting fuel, and an ignition device 28 for igniting the fuel. The electronic control unit 40 controls the operating state of the engine 21 through control of the opening degree of the throttle valve 26, control of the amount and timing of fuel injection of the injector 27, and control of the ignition timing of the ignition device 28. The electronic control unit 40 controls the power supplied to and received from the battery 12 through the first inverter 13 and the second inverter 14, thereby controlling the driving/regenerative torque of the first motor 22 and the second motor 31. Further, the electronic control unit 40 controls the gear stage of the transmission 25 and the engaged/disengaged state of each of the first clutch 23 and the second clutch 24.

<Switching of Traveling Mode>

The electronic control unit 40 switches the traveling mode of the hybrid electric vehicle according to the traveling state and the charging state of the battery 12. The electronic control unit 40 uses two traveling modes, i.e., a hybrid traveling mode and an electric traveling mode in normal traveling.

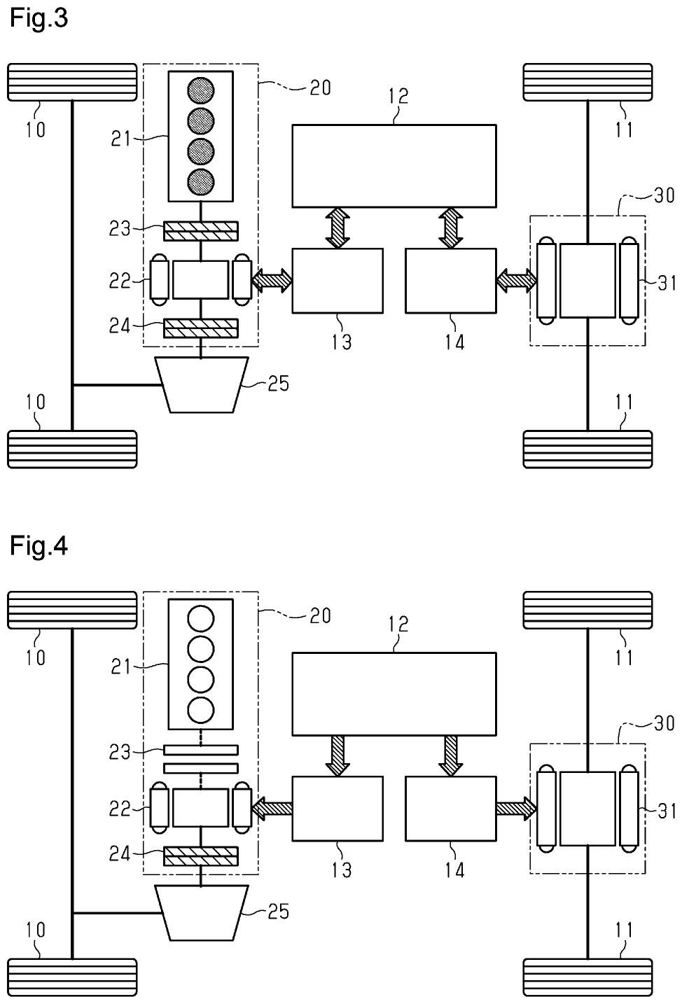

FIG. 3 shows a state of the drive system of the hybrid electric vehicle in the hybrid traveling mode. During traveling in the hybrid traveling mode, the electronic control unit 40 connects the engine 21 to the front wheels 10 by engaging both the first clutch 23 and the second clutch 24. Then, the electronic control unit 40 causes the hybrid electric vehicle to travel in a state in which the engine 21 is operating.

FIG. 4 shows a state of the drive system of the hybrid electric vehicle in the electric traveling mode. During traveling in the hybrid traveling mode, the electronic control unit 40 disengages the first clutch 23 and engages the second clutch 24. That is, the electronic control unit 40 connects the first motor 22 to the front wheels 10 while disconnecting the engine 21 from the front wheels 10. The electronic control unit 40 generates driving force by causing at least one of the first motor 22 and the second motor 31 to perform the driving operation.

<Diagnosis Process of Engine 21>

The electronic control unit 40 performs diagnosis of sensors and systems of the engine 21. An individual execution condition is set for each of the diagnosis items of the engine 21. In the following description, a diagnosis for which the execution condition is set such that the diagnosis is performed during a load operation of the engine 21 will be referred to as a load operation diagnosis. In addition, a diagnosis for which the execution condition is set such that the diagnosis is performed during an idling operation of the engine 21 will be referred to as an idling operation diagnosis. Further, a process of the electronic control unit 40 for executing the load operation diagnosis will be referred to as a load operation diagnosis process, and a process of the electronic control unit 40 for executing the idling operation diagnosis will be referred to as an idling operation diagnosis process. The load operation diagnosis operation includes a diagnosis of the exhaust gas sensor 47, the fuel pressure sensor 48, the exhaust gas purification catalyst, the catalyst warm-up system, the fuel vapor treatment system, the exhaust gas recirculation system, the fuel supply system, and the variable valve system. The idling operation diagnosis includes a diagnosis of an idling speed control (ISC) system.

Such a diagnosis is executed when the engine 21 is in an operating state satisfying the execution condition. When the vehicle control is performed normally, the operating state of the engine 21 is determined by the situation at each time. Therefore, depending on the situation, the execution condition may not be satisfied for a long time after the hybrid electric vehicle starts traveling. On the other hand, the electronic control unit 40 executes an early execution process of the load operation diagnosis to enable early execution of the load operation diagnosis. Further, the electronic control unit 40 executes an early execution process of the idling operation diagnosis to enable early execution of the idling operation diagnosis.

<Early Execution Process of Load Operation Diagnosis>

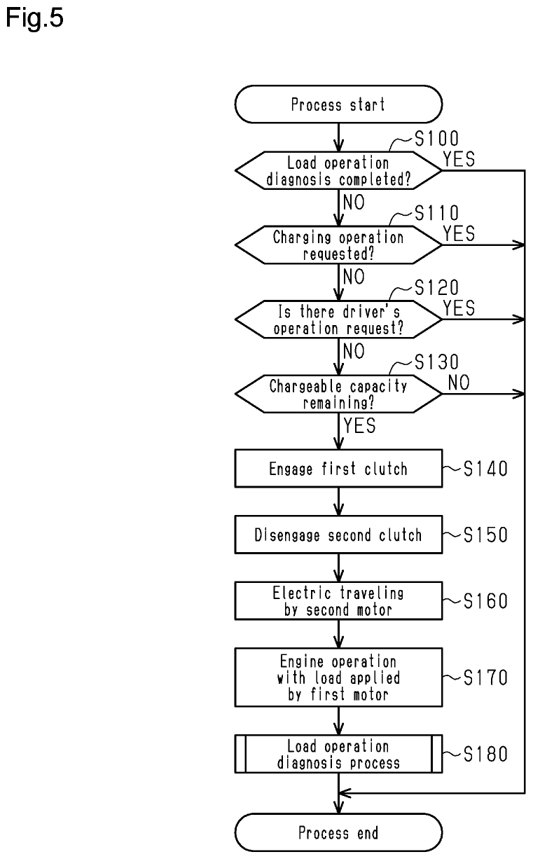

FIG. 5 shows a flowchart of the processes executed by the electronic control unit 40 for the early execution process of the load operation diagnosis. The electronic control unit 40 repeatedly executes the process of the flowchart of FIG. 5 at predetermined control intervals.

When the process of FIG. 5 is started, the electronic control unit 40 first determines in step S100 whether the load operation diagnosis has been completed after the hybrid electric vehicle has started to travel this time. If the load operation diagnosis has already been completed (YES), the electronic control unit 40 ends the current process. If the load operation diagnosis has not been completed (NO), the electronic control unit 40 proceeds to step S110.

When the process proceeds to step S110, in step S110, the electronic control unit 40 determines whether charging operation of the engine 21 is requested. When the charging operation is requested (YES), the electronic control unit 40 ends the current process, and when the charging operation is not requested (NO), the electronic control unit 40 proceeds to step S120. The charging operation of the engine 21 refers to operation of the engine 21 for causing the first motor 22 to perform the regenerative operation. The charging operation of the engine 21 is requested when the charge amount of the battery 12 is reduced to a certain amount or less.

When the process proceeds to step S120, in step S120, the electronic control unit 40 determines whether there is a driver's operation request for the engine 21. If there is a driver's operation request (YES), the electronic control unit 40 ends the current process, and if there is no driver's operation request (NO), the electronic control unit 40 proceeds to step S130. The presence or absence of the driver's operation request indicates whether or not the engine 21 needs to operate to ensure the driving force requested by the driver through depression of the accelerator pedal. When the maximum value of the driving force that can be generated by the second motor 31 is greater than the driving force requested by the driver, it is determined that there is a driver's operation request.

When the process proceeds to step S130, in step S130, the electronic control unit 40 determines whether the battery 12 has a remaining chargeable capacity that is greater than or equal to a certain level. If it is determined that there is no remaining chargeable capacity that is equal to or greater than the certain level (NO), the electronic control unit 40 ends the current process. If it is determined that there is a remaining chargeable capacity that is equal to or greater than the certain level (YES), the electronic control unit 40 advances the process to step S140. The difference between the current charge amount and the full charge amount of the battery 12 is referred to as the remaining chargeable capacity of the battery 12. When the difference is equal to or greater than a predetermined value, the electronic control unit 40 determines that the battery 12 has the remaining chargeable capacity that is equal to or greater than the certain level.

When the process proceeds to step S140, the electronic control unit 40 engages the first clutch 23 in step S140. In the following step S150, the electronic control unit 40 disengages the second clutch 24. As a result, the engine 21 and the first motor 22 are coupled to each other and disconnected from the front wheels 10. Then, at the next step S160, the electronic control unit 40 starts the electric traveling of the hybrid electric vehicle by the driving force generated by the second motor 31. Further, the electronic control unit 40 starts the load operation of the engine 21 at the following step S170. That is, the electronic control unit 40 at this time operates the engine 21 in a state in which a load is applied to the engine 21 by performing the regenerative operation of the first motor 22. Then, in step S180, the electronic control unit 40 controls the engine 21 and the first motor 22 so as to satisfy the execution condition of the diagnosis, executes the load operation diagnosis process, and then ends the process of FIG. 5.

<Early Execution Process of Idling Operation Diagnosis>

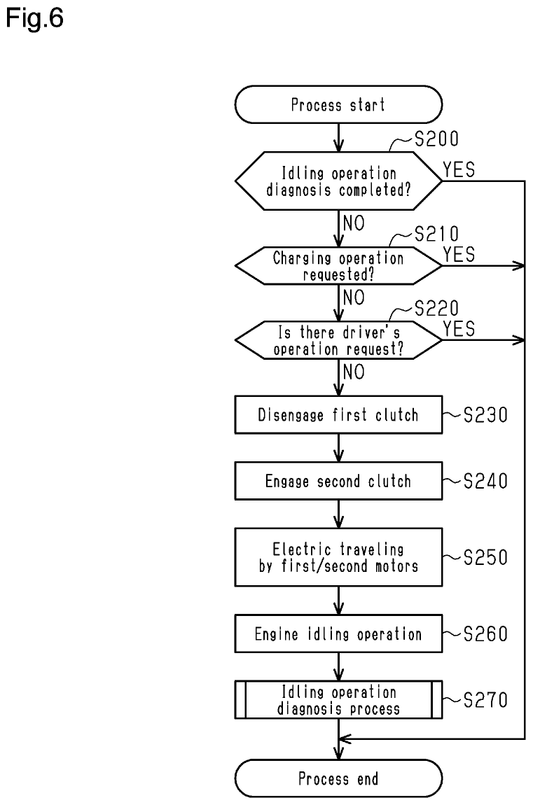

FIG. 6 shows a process procedure of ty¥he early execution process of idling operation diagnosis. The electronic control unit 40 repeatedly executes the process of FIG. 6 at predetermined control intervals.

When the process of FIG. 6 is started, the electronic control unit 40 first determines in step S200 whether the idling operation diagnosis has been completed after the hybrid electric vehicle has started to travel. If the idling operation diagnosis has already been completed (YES), the electronic control unit 40 ends the current process. If the idling operation diagnosis has not been completed (NO), the electronic control unit 40 proceeds to step S210.

When the process proceeds to step S210, in step S210, the electronic control unit 40 determines whether the charging operation of the engine 21 is requested. When the charging operation is requested (YES), the electronic control unit 40 ends the current process, and when the charging operation is not requested (NO), the electronic control unit 40 proceeds to step S220. It is determined whether there is a driver's operation request for the engine 21. If there is a driver's operation request (YES), the electronic control unit 40 ends the current process. If there is no driver's operation request (NO), the electronic control unit 40 proceeds to step S230. In step S230, when the maximum value of the driving force that can be generated by the first motor 22 and the second motor 31 is greater than the driving force requested by the driver, it is determined that there is a driver's operation request.

When the process proceeds to step S230, the electronic control unit 40 disengages the first clutch 23 in step S230. In the following step S240, the electronic control unit 40 engages the second clutch 24. As a result, in the first power unit 20, the engine 21 is disconnected from the front wheels 10 and the first motor 22 is connected to the front wheels 10. Then, at the next step S250, the electronic control unit 40 starts electrically traveling by the first motor 22 and the second motor 31. In step S260, the electronic control unit 40 starts the idling operation of the engine 21. Then, in step S270, the electronic control unit 40 executes the idling operation diagnosis, and then ends the process of FIG. 6.

In the present embodiment, steps S140 to S170 in FIG. 5 correspond to the early execution process of the load operation diagnosis. In the present embodiment, the process of steps S230 to S260 in FIG. 6 correspond to the early execution process of the idling operation diagnosis.

### Operational Advantages of Embodiment

Operation and advantages of the present embodiment configured as described above will be described.

When the load operation diagnosis has not been completed, the electronic control unit 40 executes the early execution process of the load operation diagnosis in the following manner. The electronic control unit 40 in this case connects the engine 21 and the first motor 22 to each other and disconnects the engine 21 and the first motor 22 from the front wheels 10 by engaging the first clutch 23 and disengaging the second clutch 24. The electronic control unit 40 drives the rear wheels 11 by the second motor 31 to perform the electric traveling of the hybrid electric vehicle, and applies load to the engine 21 by the first motor 22 to perform load operation of the engine 21.

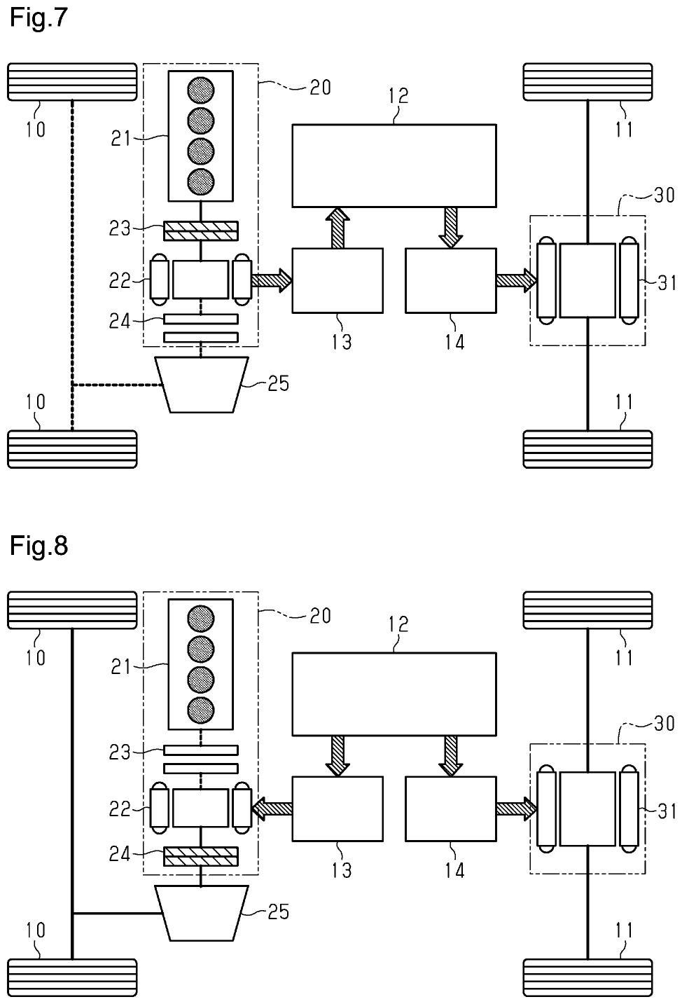

FIG. 7 shows a state of the drive system of the hybrid electric vehicle at this time. As shown in FIG. 3, the engine 21 and the first motor 22 are disconnected from the front wheels 10. Since the engine 21 and the first motor 22 are connected to each other at this time, the load of the engine 21 changes due to the regenerative torque of the first motor 22. Therefore, at this time, by controlling the output of the engine 21 and the regenerative torque of the first motor 22, the operating state of the engine 21 can be changed. Therefore, the electronic control unit 40 controls the engine 21 to an operating state that satisfies the execution condition, and executes the load operation diagnosis process.

If the battery 12 is fully charged or nearly fully charged, the battery 12 cannot be charged with the electric power generated by the regenerative operation of the first motor 22. Therefore, the electronic control unit 40 executes the early execution process of the load operation diagnosis in the above-described manner only when the remaining charging capacity of the battery 12 is sufficient.

When the idling operation diagnosis is not completed, the electronic control unit 40 executes the early execution process of the idling operation diagnosis in the following manner. That is, the electronic control unit 40 in this case disconnects the engine 21 from the front wheels 10 in a state in which the first motor 22 is connected to the front wheels 10 by disengaging the first clutch 23 and engaging the second clutch 24. Then, the electronic control unit 40 executes the idling operation diagnosis in a state in which the engine 21 is in the idling operation while performing the electric traveling of the hybrid electric vehicle by at least one of the first motor 22 and the second motor 31.

FIG. 8 shows the state of the drive system of the hybrid electric vehicle at this time. As shown in the figure, the engine 21 at this time is in a no-load state, in which the engine 21 is not connected to an external load. The electronic control unit 40 performs the idling operation of the engine 21 in such a state and executes the diagnosis process during the idling operation. At this time, the first motor 22 is connected to the front wheels 10 and the second motor 31 is connected to the rear wheels 11. Therefore, the electric traveling of the hybrid electric vehicle is performed by driving the front wheels 10 by the first motor 22, driving the rear wheels 11 by the second motor 31, or both of them.

According to the diagnosing apparatus for a hybrid electric vehicle of the present embodiment described above, the following advantages are obtained.
(1) When the load operation diagnosis process is not completed, the electronic control unit 40 executes the following early execution process of the load operation diagnosis. In the early execution process of the load operation diagnosis, the electronic control unit 40 engages the first clutch 23 and disengages the second clutch 24 to cause the hybrid electric vehicle to travel by the driving force generated by the second motor 31. Then, the electronic control unit 40 performs the load operation of the engine 21 so as to satisfy the execution condition of the load operation diagnosis process in a state in which the load is applied by the first motor 22. Thus, the load operation diagnosis process can be executed regardless of the travel state of the hybrid electric vehicle. Therefore, the diagnosing apparatus for a hybrid electric vehicle according to the present embodiment enables early execution of the load operation diagnosis.
(2) In the early execution process during the load operation, the load is applied to the engine 21 by the regenerative operation of the first motor 22. Therefore, if the early execution process during the load operation is executed in a state in which the battery 12 is fully charged or in a state close thereto, the battery 12 may be overcharged. In this regard, in the present embodiment, the early execution process of the load operation diagnosis is executed on condition that the battery 12 has a certain amount or more of the remaining charging capacity. Therefore, the battery 12 is less likely to be overcharged.
(3) In the early execution process of the load operation diagnosis, the first motor 22 generates electric power, but the second motor 31 consumes electric power. Therefore, the charge amount of the battery 12 may be reduced. In this regard, the electronic control unit 40 executes the early execution process of the load operation diagnosis on condition that the operation of the engine 21 for charging the battery 12 is not requested. Therefore, insufficient charging of the battery 12 due to the execution of the early execution process of the load operation diagnosis is less likely to occur.
(4) The electronic control unit 40 executes the early execution process of the load operation diagnosis on condition that the maximum value of the driving force that can be generated by the second motor 31 is greater than the driving force requested by the driver. Therefore, it is possible to avoid the deterioration of the drivability due to the shortage of the driving force of the hybrid electric vehicle by the execution of the early execution process of the load operation diagnosis.
(5) When the idling operation diagnosis process is not completed, the electronic control unit 40 executes the following early execution process of the idling operation diagnosis. In the early execution process of the idling operation diagnosis, the electronic control unit 40 disengages the first clutch 23 and engages the second clutch 24. Then, the electronic control unit 40 performs the idling operation of the engine 21 while causing the hybrid electric vehicle to travel by the driving force generated by one or both of the first motor 22 and the second motor 31. Thus, the idling operation diagnosis can be performed regardless of the traveling state of the hybrid electric vehicle. Therefore, the diagnosis apparatus for a hybrid electric vehicle according to the present embodiment enables early execution of idling operation diagnosis.
(6) The electronic control unit 40 executes the early execution process of the idling operation diagnosis on the condition that the operation of the engine 21 for charging the battery 12 is not requested. Therefore, insufficient charging of the battery 12 due to the execution of the early execution process of the idling operation diagnosis is less likely to occur.
(7) The electronic control unit 40 executes the early execution process of the idling operation diagnosis on condition that the maximum value of the driving force that can be generated by the first motor 22 and the second motor 31 is greater than the driving force requested by the driver. Therefore, it is possible to avoid deterioration of drivability due to insufficient driving force of the hybrid electric vehicle by executing the early execution process of the idling operation diagnosis.

The present embodiment can be modified as follows. The present embodiment and the following modifications can be implemented in combination with each other if there is no technical contradiction. The execution conditions of the early execution processes of the load operation diagnosis and the idling operation diagnosis may be changed when appropriate.

The diagnosis device may be configured to execute only the early execution process of the load operation diagnosis without executing the early execution process of the idling operation diagnosis.

In the load operation diagnosis process, a plurality of diagnoses during load operation may be executed simultaneously or sequentially. Similarly, in the idling operation diagnosis, a plurality of diagnoses during the idling operation may be executed simultaneously or sequentially.

The first motor 22 and the second motor 31 of the above-described embodiment have both a function as an electric motor that generates a driving force in response to power supply and a function as a generator that receives force from the outside and generates electric power. If electric traveling by the driving force of the first motor 22 is not performed, a rotary electric machine dedicated to regenerative driving that does not have a function as an electric motor may be employed as the first motor 22. In addition, if regenerative power generation by the second motor 31 is not performed, a rotary electric machine dedicated to power driving that does not have a function as a generator may be employed as the second motor 31.

The diagnosing apparatus of the present embodiment can be similarly used in a hybrid electric vehicle in which the first power unit 20 and the second power unit 30 are configured to drive the same wheels.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A diagnosing apparatus for a hybrid electric vehicle, wherein
the hybrid electric vehicle includes:
an engine that generates driving force by combustion of fuel;
a first motor that generates electric power by receiving external force;
a second motor that generates force in response to power supply;
a battery that is charged and discharged; and
a first clutch and a second clutch that selectively allow for and interrupt force transmission,
the first clutch, the first motor, and the second clutch are arranged in that order from the engine toward wheels in a transmission path of the driving force,
the diagnosing apparatus is configured to execute:
a load operation diagnosis process of diagnosing the engine when a specified execution condition is satisfied during a load operation of the engine; and
an early execution process of a load operation diagnosis, the early execution process performing the load operation of the engine to satisfy an execution condition of the load operation diagnosis process in a state in which load is applied to the engine by the first motor while the first clutch is engaged and the second clutch is disengaged so that the vehicle travels with the driving force generated by the second motor.

2. The diagnosing apparatus for the hybrid electric vehicle according to claim 1, wherein the diagnosing apparatus is configured to execute the early execution process of the load operation diagnosis on condition that the battery has a remaining chargeable capacity that is equal to or greater than a certain level.

3. The diagnosing apparatus for the hybrid electric vehicle according to claim 1, wherein the diagnosing apparatus is configured to execute the early execution process of the load operation diagnosis on condition that operation of the engine for charging the battery is not requested.

4. The diagnosing apparatus for the hybrid electric vehicle according to claim 1, wherein the diagnosing apparatus is configured to execute the early execution process of the load operation diagnosis on condition that a maximum value of the driving force that can be generated by the second motor is greater than a driving force requested by a driver.

5. The diagnosing apparatus for the hybrid electric vehicle according to claim 1, wherein
the first motor generates a driving force in response to power supply, and
the diagnosing apparatus is configured to further executes
an idling operation diagnosis process of diagnosing the engine on condition that the engine is in an idling operation, and
an early execution process of the idling operation diagnosis, the early execution process performing the idling operation of the engine while the first clutch is disengaged and the second clutch is engaged so that the vehicle travels with the driving force generated by one or both of the first motor and the second motor.

6. The diagnosing apparatus for the hybrid electric vehicle according to claim 5, wherein the diagnosing apparatus is configured to execute the early execution process of the idling operation diagnosis on condition that driving of the engine for charging the battery is not requested.

7. The diagnosing apparatus for the hybrid electric vehicle according to claim 5, wherein the diagnosing apparatus is configured to execute the early execution process of the idling operation diagnosis on condition that a maximum value of the driving force that can be generated by the first motor and the second motor is greater than a driving force requested by a driver.

8. A diagnosing method for a hybrid electric vehicle, wherein
the hybrid electric vehicle includes:
an engine that generates driving force by combustion of fuel;
a first motor that generates electric power by receiving external force;
a second motor that generates force in response to power supply;
a battery that is charged and discharged; and
a first clutch and a second clutch that selectively allows for and interrupts force transmission,
the first clutch, the first motor, and the second clutch are arranged in that order from the engine toward wheels in a transmission path of the driving force,
the diagnosing method comprises executing:
a load operation diagnosis process of diagnosing the engine when a specific execution condition is satisfied during a load operation of the engine; and
an early execution process of a load operation diagnosis, the early execution process performing the load operation of the engine to satisfy an execution condition of the load operation diagnosis process in a state in which load is applied to the engine by the first motor while the first clutch is engaged and the second clutch is disengaged so that the vehicle travels with the driving force generated by the second motor.
